(19) United States
(12) Patent Application Publication
(10) Pub. No.: US 2026/0088575 A1
(43) Pub. Date: Mar. 26, 2026

(54) CIRCUIT BOARD PLUG-IN CONNECTOR AND CIRCUIT BOARD

(71) Applicant: MD ELEKTRONIK GmbH, Waldkraiburg (DE)

(72) Inventors: Daniel BOCK, Schönberg (DE); Markus GERL, Schonstett (DE); Andrea SEYFERT, Taufkirchen (DE); Helmut PRITZ, Ampfing (DE); Florian KEINDL, Mühldorf (DE)

(73) Assignee: MD ELEKTRONIK GmbH, Waldkraiburg (DE)

(21) Appl. No.: 19/317,251

(22) Filed: Sep. 3, 2025

(30) Foreign Application Priority Data
Sep. 26, 2024 (DE) 10 2024 127 927.3

(51) Int. Cl. H01R 13/6594; H01R 12/75

(52) U.S. Cl. CPC H01R 13/6594; H01R 12/75

(57) ABSTRACT

A circuit board plug-in connector for high-frequency signals, the circuit board plug-in connector has a plug face for reversible connection to a corresponding plug-in connector for high-frequency signals, and a circuit board interface for permanent connection to a circuit board. The plug face and the circuit board interface have at least one continuous electrically conductive electrical conductor. The plug face has a fixed shield for electromagnetic shielding of the electrical conductor, and the circuit board interface has a shielding element, mounted movably relative to the electrical conductor, for electromagnetic shielding of the electrical conductor.

### FIELD

The present invention relates to a circuit board plug-in connector and a circuit board having a corresponding circuit board plug-in connector.

### BACKGROUND

A cable may be connected to a printed circuit board via a plug-in connection. The printed circuit board may be referred to as a circuit board or PCB. For the plug-in connection, the printed circuit board has a circuit board plug-in connector, while a corresponding plug-in connector is arranged at one end of the cable. For example, high-frequency electrical signals may be transmitted via the cable. A shielded cable may then be used. For continuous shielding, the plug-in connection may likewise be of shielded design. The shielding of the plug-in connection may then be electrically conductively connected to a ground potential of the printed circuit board, for example via a separate shielding contact or ground contact.

If the circuit board plug-in connector is connected to the printed circuit board, component tolerances and/or manufacturing tolerances may prevent the circuit board plug-in connector from resting directly on the printed circuit board. Although electrical contacts of the circuit board plug-in connector and the shielding may then be electrically conductively connected to the respective conductor tracks of the printed circuit board, a resulting gap between the printed circuit board and the circuit board plug-in connector may disturb the effect of the shielding. Electromagnetic fields may be coupled out of the electrical conductors through the gap and/or electromagnetic fields may be coupled into the electrical contacts.

The gap may be minimized by connecting the circuit board plug-in connector to the printed circuit board in a position-controlled manner. In this case, the printed circuit board and the circuit board plug-in connector are pressed together with force until the printed circuit board and the circuit board plug-in connector are arranged within a narrow positional tolerance range. The circuit board plug-in connector is then fixed. If an electrically conductive connection is provided or the gap is small enough, the coupling-in and coupling-out of the electromagnetic fields may be approximately prevented.

### SUMMARY

There may be a need for a circuit board plug-in connector which may be connected to a printed circuit board in a simple, reliable and/or cost-effective manner. In particular, there may be a need for a circuit board plug-in connector with increased assembly tolerances and/or positional tolerances. Furthermore, there may be a need for a circuit board having a corresponding circuit board plug-in connector.

Such a need may be met by the subject matter of the independent claims. Advantageous embodiments are set out in the dependent claims, the following description and the attached figures.

A first aspect of the invention relates to a circuit board plug-in connector which is suitable, in particular but not necessarily, for high-frequency signals. The circuit board plug-in connector has a plug face for reversible connection to a corresponding plug-in connector which is suitable, in particular but not necessarily, for high-frequency signals, and a circuit board interface for permanent connection to a circuit board. The plug face and the circuit board interface have at least one continuous electrical conductor. The plug face has a fixed shield for electromagnetic shielding of the electrical conductor. The circuit board interface has a shielding element, mounted movably relative to the electrical conductor and to the shield, for electromagnetic shielding of the electrical conductor.

A second aspect of the invention relates to a circuit board having at least one circuit board plug-in connector according to the first aspect. The circuit board interface is permanently connected to the circuit board. The movably mounted shielding element bears against the circuit board, is electrically conductively connected to a ground potential of the circuit board and bridges a gap between the circuit board and the circuit board plug-in connector.

Without restricting the scope of the invention in any way, ideas and possible features relating to embodiments of the invention may be regarded, inter alia, as being based on the concepts and knowledge described below.

A circuit board plug-in connector may form a part of a plug-in connection which part is fixedly connected to a circuit board or a printed circuit board or a PCB. The circuit board plug-in connector has a pluggable side for forming the plug-in connection and a side suitable for permanent connection to the circuit board. The pluggable side is referred to here as the plug face. The fixedly connectable side is referred to here as the circuit board interface.

The plug-in connection may be configured for transmitting high-frequency signals. The plug-in connection may transmit the high-frequency signals from and/or to the outside between the two parts of the plug-in connection without or with a tolerably low interference. For this purpose, both parts may have a continuous electrically conductive shielding which is grounded or at least connected to a ground potential.

If the circuit board plug-in connector is connected to the circuit board, the shielding thereof and thus in particular also the shielding of the plug face is also electrically conductively connected to a ground potential of the circuit board.

Conventionally, the circuit board interface may have contact pins which are arranged in bores of the circuit board and are then connected to conductor tracks of the circuit board, for example by means of flow soldering. The shielding may have its own contact pin. In this case, a housing of the circuit board plug-in connector may be placed directly onto a surface of the circuit board prior to soldering without exerting force. Thus, a gap between the housing and the printed circuit board may be minimized. The shielding may reach as far as the gap directly. As a result of the minimum gap, virtually no interruption of the shielding occurs functionally.

Alternatively, contact areas of the circuit board interface may be placed on deposits of solder paste and connected to the conductor tracks arranged under the deposits by means of reflow soldering. The shielding may also have its own contact area. As a result of the solder paste or the solder resulting therefrom, a small gap may arise between the housing and the printed circuit board. Under certain circumstances, the gap may already lead to coupling-in and/or coupling-out of interference signals. However, the effects of the gap may lie within a specification of the circuit board interface.

Soldering may be complex and expensive. Complex circuit boards which have low-melting components, such as housings, may be damaged by the high temperatures.

In particular if the circuit board interface is formed with fastening pins in the form of press-in pins for pressing into corresponding bores of the printed circuit board, component tolerances, positional tolerances, assembly tolerances and tool tolerances may lead to a larger gap between the housing and the printed circuit board. Even if the shielding has its own press-in pin for making contact with the ground potential of the circuit board, the size of the gap and thus the shielding in the region of the gap may not be precisely defined and lead to coupling-in and/or coupling-out of interferences.

In the approach presented here, the gap is eliminated independently of the design of the circuit board interface by a movable, electrically conductive shielding element of the circuit board plug-in connector being placed on the circuit board and resting directly on the circuit board. The shielding element may in this case consist of an electrically conductive material such as, in particular, metal or be coated with such a material. In this case, the shielding element may, for example, be placed on a contact area of the circuit board connected to the ground potential and make electrically conductive contact therewith. Alternatively or additionally, the shielding element may be electrically conductively connected to a ground contact of the circuit board interface and the latter may in turn be connected to the ground potential of the circuit board. The shielding element is moved relative to the circuit board plug-in connector as far as necessary so that it rests on the circuit board. As a result of the direct resting, no gap or only a minimum gap may exist between the shielding element and the circuit board. The gap may also, for example, be interrupted once or more than once by a crenellated structure.

The shielding element may be configured such as to advance, that is to say project further out of the circuit board plug-in connector in a starting position than in a predetermined end position of the circuit board plug-in connector. The shielding element will then close the gap before the circuit board plug-in connector reaches its end position. The shielding element is then moved back to the circuit board by the contact during the positioning of the circuit board plug-in connector, while the circuit board plug-in connector is moved into its end position.

Alternatively, the shielding element in the starting position may be arranged in a neutral position or even in a retracted position. The circuit board plug-in connector may then be brought closer to the circuit board at least as far as an intended neutral position before the shielding element makes contact with the circuit board. If the circuit board plug-in connector is arranged in the end position and is connected to the circuit board, the shielding element may be moved in the direction of the circuit board and close the gap.

The shielding element may be arranged coaxially with respect to the electrical conductor. In other words, the shielding element may be of cylindrical design and surround the electrical conductor accommodated in its interior. The shielding element may be mounted movably axially relative to the electrical conductor in a main body of the circuit board plug-in connector. In other words, the shielding element may be displaced relative to the electrical conductor and/or the main body in the axial direction at least once or preferably reversibly, in particular without its integrity and/or its functionality being disturbed in the process. The main body may be electrically conductive and electrically conductively connected to the shielding element. An electrical insulator may be arranged between the main body and the electrical conductor and/or an electrically insulating gap may be formed.

The shielding element may be positioned at three different positions. The shielding element may be arranged outside the main body, for example. In this case, the shielding element encloses the main body. Alternatively, the shielding element may be arranged between the main body and the shield. This variant is illustrated in the figures. As a further alternative, the shielding element may be arranged within the shield. Here, the shield encloses the shielding element. In this case, there is always an overlap between the respective shielding components, that is to say the main body, the shielding element and the shield, in order to achieve good shielding.

According to one embodiment, the circuit board interface has a distance tolerance range for making contact with the circuit board in order to compensate for component tolerances and/or manufacturing tolerances. The movable shielding element may be mounted movably at least within the distance tolerance range. The distance tolerance range may extend from a structurally greatest possible distance between the circuit board plug-in connector and the circuit board to a structurally smallest possible distance between the circuit board plug-in connector and the circuit board. In other words, the distance tolerance range may specify a distance between a position at which the circuit board plug-in connector is at a maximum distance from the circuit board according to structural specifications and a position at which the circuit board plug-in connector is at a minimum distance from the circuit board according to the structural specifications. The shielding element is displaceable relative to the electrical conductor along the entire distance tolerance range. As a result of this movability over the entire distance tolerance range, the shielding element may reliably bridge the gap between the two components in all possible positions of the circuit board plug-in connector relative to the circuit board. Thus, the electrical conductor may be surrounded along its entire length from the circuit board to the plug face on the outside either by the fixed shield or by the shielding element or even by both components and thus be shielded reliably.

The shielding element may have a stop for preventing removal from the circuit board plug-in connector. The stop may prevent movement of the shielding element beyond the structurally greatest possible distance.

The circuit board interface may have fastening pins for pressing into the circuit board. The fastening pins may be pressable within the distance tolerance range. The electrical conductor may likewise be formed on the circuit board interface as a press-in contact. The press-in contact may likewise be pressable within the distance tolerance range. A fastening pin for pressing-in or a press-in contact may be referred to as a press-in pin. The fastening pin or the press-in contact may have a press-in region. The press-in region may be configured as a spring-elastic region which is radially compressible. In a starting state, the press-in region may have a larger diameter than a bore of the circuit board provided for this purpose. During pressing-in, the press-in region may be compressed and clamp in the bore by a resulting restoring force. The press-in region may have a conical or cone-shaped starting region, by means of which the press-in region is centered in the bore. The press-in region may be larger than the distance tolerance range by at least one material thickness of the circuit board. If the circuit board plug-in connector and the circuit board have a distance within the distance tolerance range, the fastening pins develop an intended holding force in the bores of the circuit board. As a result, the circuit board plug-in connector and the circuit board are virtually freely positionable within the distance tolerance range. The movable shielding element ensures continuous shielding of the electrical conductor in every position.

In an uninstalled state, the shielding element may project out of a main body of the circuit board plug-in connector beyond a stop of the circuit board interface at least by a maximum distance tolerance of the circuit board interface. The shielding element may thus already be born on the circuit board if the circuit board plug-in connector is arranged at a maximum distance from the circuit board. As a result of the projection, no separate work step of subsequently pressing on the shielding element is required.

The shielding element may be supported on a main body of the circuit board plug-in connector via an elastic spring element. The elastic spring element may be, for example, a spring, in particular a spiral spring, or a component consisting of an elastomer. The elastic spring element may be elastically deformed if the shielding element is moved relative to the main body. A restoring force of the spring element may elastically pretension the shielding element relative to the main body, in particular push it out of the main body. If the shielding element bears against the circuit board, the restoring force of the spring element may correspond to a pressing force of the shielding element against the circuit board. In particular, the shielding element may project out of the main body to the maximum extent when the spring element is relaxed. In the projecting state, the shielding element may also bear against a stop and the spring element may be pretensioned. The spring element may then be tensioned to an ever greater extent, the further the shielding element is pushed into the main body. In the installed state, the circuit board and the circuit board plug-in connector may execute relative movements on account of environmental influences, such as heat, cold, moisture or dryness. If the distance between the circuit board plug-in connector and the circuit board should change as a result of these relative movements, the restoring force of the spring element may change a relative position of the shielding element with respect to the circuit board plug-in connector and hold the gap permanently closed.

The shielding element may be pressed into a contact area of the circuit board which contact area is at the ground potential. For this purpose, for example, at least one partial region of the shielding element may have an interference fit in a main body of the circuit board plug-in connector. The partial region and/or the main body may be configured to be elastically deformed upon a relative movement of the shielding element. The shielding element may have at least one partial region which has a larger dimension than a cutout for the shielding element. The partial region and/or the main body may be configured to enable the relative movement when a minimum force on the shielding element is exceeded. The minimum force may be required for elastically deforming the partial region and/or the main body. The minimum force for the relative movement may correspond to a minimum pressing force of the shielding element against the circuit board. As a result of the pressing force, the shielding element may be pressed slightly into a surface of the circuit board and a reliable electrical contact with the ground potential of the circuit board may be established.

The shielding element may penetrate into a contact area of the circuit board which contact area is at the ground potential. For this purpose, the shielding element may, for example, have a crenellated structure at a contact point with respect to the circuit board. A crenellated structure may have elevations and depressions. The elevations project further from the circuit board plug-in connector than the depressions. The elevations are first born on the circuit board. The elevations form a smaller contact area with respect to the circuit board than a cross-sectional area of the shielding element. As a result of the reduced contact area, an increased surface pressure on the circuit board may be achieved with the same pressing force. The elevations may be pressed into the surface of the circuit board as a result of the increased surface pressure and establish a reliable electrical contact with the ground potential of the circuit board.

Alternatively or additionally, the shielding element may be soldered to the contact area of the circuit board which contact area is at the ground potential. The soldering may be effected, for example, by placing the shielding element on at least one deposit of solder paste and subsequent reflow soldering. A particularly reliable electrical and mechanical contact between the circuit board and the shielding element may be achieved by soldering.

The shielding element may have at least one anchoring element, wherein the anchoring element is configured to be arranged in an aperture of the circuit board and to anchor the shielding element on a rear side of the circuit board. If the circuit board plug-in connector is connected to the circuit board, the at least one anchoring element of the shielding element may be arranged in the aperture of the circuit board and anchor the shielding element on a rear side of the circuit board. An anchoring element may project beyond a contact area of the shielding element to a front side of the circuit board. The anchoring element may be at least as long as the circuit board is thick. The circuit board may have an aperture, provided specifically for this purpose, to the rear side. When the circuit board plug-in connector is placed on the circuit board, the anchoring element may be inserted into the aperture. During insertion, the anchoring element may be elastically deformed, for example. On the rear side, the anchoring element may spring back and latch. Alternatively or additionally, the anchoring element may be soldered on the rear side in order to make electrical contact with the ground potential. This may be effected, for example, by means of flow soldering. The anchoring element may also be plastically deformed on the rear side. For example, the anchoring element may be bent over on the rear side. The plastically deformed anchoring element may no longer be retracted through the aperture.

It is pointed out that possible features and advantages of embodiments of the invention are described partly with reference to a circuit board plug-in connector and partly with reference to a circuit board having a corresponding circuit board plug-in connector. A person skilled in the art will recognize that the features described for individual embodiments may be transferred, adapted and/or exchanged in an analogous and suitable manner to other embodiments in order to arrive at further embodiments of the invention and possibly at synergy effects.

### BRIEF DESCRIPTION OF THE DRAWINGS

Advantageous embodiments of the invention are explained further below with reference to the attached drawings, wherein neither the drawings nor the explanations are to be interpreted as limiting the invention in any way.

FIG. 1 shows a sectional illustration of a circuit board plug-in connector according to one exemplary embodiment.

FIG. 2 shows a sectional illustration of a circuit board having a circuit board plug-in connector according to one exemplary embodiment.

FIG. 3 shows a sectional illustration of a secured circuit board plug-in connector according to one exemplary embodiment.

The figures are merely schematic and not true to scale. Identical reference signs denote identical or identically acting features in the different drawings.

### DETAILED DESCRIPTION

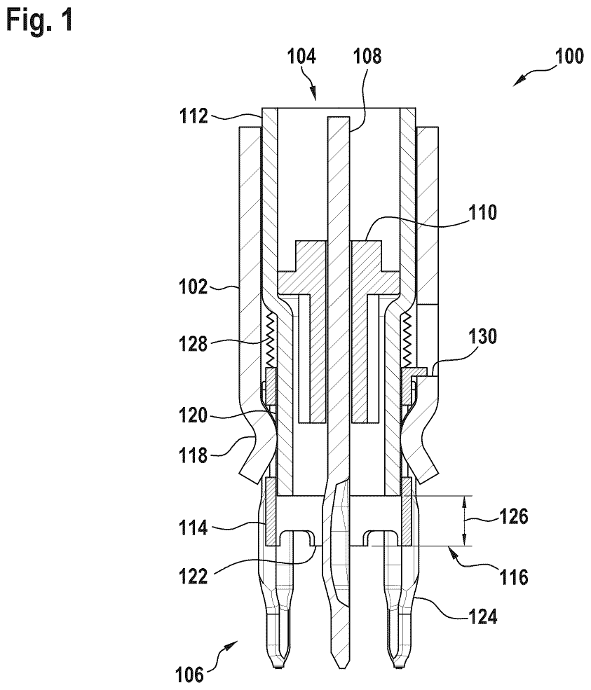

FIG. 1 shows a sectional illustration of a circuit board plug-in connector 100 according to one exemplary embodiment. The circuit board plug-in connector 100 has a main body 102 which has, on a first side, a plug face 104 of a releasable plug-in connection to a corresponding plug-in connector and, on an opposite second side, a circuit board interface 106 for permanently connecting the circuit board plug-in connector 100 to a circuit board. At least one electrical conductor 108, which forms a pluggable plug contact at least in the plug face 104, runs through the main body 102 from the plug face 104 to the circuit board interface 106. The electrical conductor 108 is electrically separated from other electrically conductive components of the circuit board plug-in connector 100 by an insulator 110.

The circuit board plug-in connector 100 is configured to transmit high-frequency electrical signals. For this purpose, the plug face 104 has an electrically conductive shield 112. The shield 112 is substantially tubular and radially encloses the electrical conductor 108. The shield 112 shields electromagnetic fields which are emitted by the electrical conductor 108 and/or scatter into the electrical conductor 108. In the illustrated example, the shield 112 forms a plug-in contour of the plug face 104.

At the circuit board interface 106, the circuit board plug-in connector 100 has a movable, electrically conductive shielding element 114. The shielding element 114 is mounted movably in the main body 102 and configured to bridge a possible gap between the main body 102 and a circuit board. For this purpose, the shielding element 114 is movable relative to the electrical conductor 108 and to the shield 112. The shielding element 114 has the same electromagnetically shielding function as the shield 112. The shielding element 114 is likewise substantially tubular and radially encloses the other end of the electrical conductor 108. The shield 112 and the shielding element 114 overlap at least partially in all relative positions. Thus, the electrical conductor is electromagnetically shielded along its entire length or in all relative positions, even if the gap exists between the main body 102 and the circuit board. The shield 112 and the shielding element 114 are electrically conductively connected to one another. The shield 112 and/or the shielding element 114 may consist of an electrically conductive material such as, for example, metal, in particular in the form of a stamped and bent component formed from a metal sheet. Alternatively, the shield 112 and/or the shielding element 114 may be formed with an electrically non-conductive material such as, for example, plastic, which is coated at least partially with an electrically conductive material such as, for example, metal. As a result, these components may be produced in a possibly simpler, more cost-effective manner and/or with a more variable shape.

In one exemplary embodiment, the shield 112 is arranged at least partially within the shielding element 114. The shielding element 114 is therefore mounted movably in an intermediate space between the shield 112 and the main body 102. Alternatively, however, the shielding element 114 may also be arranged at least partially within the shield 112.

In one exemplary embodiment, the shielding element 114 is arranged in a defined starting position 116 in an uninstalled state of the circuit board plug-in connector 100. In the starting position 116, the shielding element 114 projects out of the main body 102 to the maximum extent and an overlap between the shield 112 and the shielding element 114 is minimal.

In one exemplary embodiment, the main body 102 has at least one elastic latching element 118 for defining the starting position 116. The latching element 118 is arranged on an outer side of the shielding element 114. The latching element 118 has a latching lug which is curved in the direction of the shielding element 114. In the starting position 116, the latching lug is arranged in a depression 120 or cutout of the shielding element 114. The latching element 118 is substantially relaxed in the depression 120. The latching lug has a sliding slope. If the shielding element 114 is placed on the circuit board when the main body 102 approaches the circuit board and is thereby moved relative to the main body 102, the sliding slope slides over an edge of the depression 120 until the latching lug is arranged on an outer side of the shielding element 114. In this case, the latching element 118 is elastically deformed and the latching lug is pressed against the outer side of the shielding element 114 with a resulting restoring force. The sliding over the edge requires a minimum force. If the circuit board plug-in connector 100 and consequently also the shielding element are pressed against the circuit board with more than the minimum force, the latching lug slides out of the depression 120. If the latching lug is pressed against the outer side of the shielding element 114, a resulting frictional force must be overcome in order to move the shielding element 114 further. However, in this case, the frictional force is less than the minimum force. If the circuit board plug-in connector 100 is brought closer to the circuit board, the shielding element 114 is thus pressed further against the circuit board with the frictional force.

In one exemplary embodiment, the shielding element has a crenellated structure 122 at a front end. The crenellated structure 122 has partial regions which project axially further in a direction away from the main body or toward the circuit board than circumferentially adjacent partial regions of the shielding element. If the shielding element 114 is pressed against the circuit board, the projecting partial regions touch the circuit board first. In the projecting partial regions, the pressing force with which the shielding element 114 is pressed against the circuit board is concentrated, as a result of which an increased contact pressure arises locally. In this case, the projecting partial regions may, for example, penetrate into a contact area of the circuit board and thus establish a reliable electrically conductive connection to a ground potential or ground of the circuit board.

In one exemplary embodiment, the circuit board interface 106 is configured for pressing into bores of the circuit board. For this purpose, the main body 102 has a plurality of fastening pins or press-fit pins 124 which are aligned parallel to the electrical conductor 108. The electrical conductor 108 is also formed as a press-fit contact. In the relaxed state, the press-fit pins 124 and the press-fit contact are thicker than a diameter of the bores of the circuit board. The press-fit pins 124 and the press-fit contact are radially elastically compressible in order to be able to adapt their outer diameter to the diameter of the bores during pressing into the bores. The press-fit pins 124 and the press-fit contact are fixed in the bores by a restoring force counter to the compression.

In one exemplary embodiment, the press-fit pins 124 and the press-fit contact are thicker, over a press-in region, than the bores. Within the press-in region, the press-fit pins 124 and the press-fit contact may clamp in the bores. In the pressed-in state, the press-in region results in a distance tolerance range 126 between the main body 102 and the circuit board. The shielding element 114 is therefore movable over at least the entire distance tolerance range 126. The distance tolerance range 126 results from the fact that the fastening may be effected within the press-in region and different distance positions are thus possible. The actual distance between the main body 102 and the circuit board is bridged by the shielding element 114 after pressing in in order to ensure continuous electromagnetic shielding.

In one exemplary embodiment, the shielding element 114 is supported on the main body 102 via an elastic spring element 128. In the starting position 116 of the shielding element 114, the spring element 128 is substantially relaxed and is tensioned to a greater extent, the further the shielding element 114 is deflected out of the starting position 116 in the direction of the main body 102. The spring element 128 opposes this deflection by a spring force rising proportionally to the deflection. If the circuit board interface 106 is connected to the circuit board, the shielding element 114 is thus pressed against the circuit board with the resulting spring force. As a result of the spring force, the shielding element 114 is pressed further against the circuit board if a relative position of the circuit board plug-in connector 100 with respect to the circuit board should change, for example, as a result of external influences. Even if the distance between the circuit board and the main body 102 should change as a result, the gap remains closed.

In one exemplary embodiment, the spring element 128 is pretensioned in the starting position 116 by a pretensioning force. The pretensioning force adds up independently of the deflection to the spring force dependent on the deflection. The spring element 128 is pretensioned, for example, if the latching element 118 is arranged in the depression 120.

In one exemplary embodiment, the starting position 116 is defined by a stop 130. Here, the stop 130 may be arranged on the main body 102 and/or on the shield 112. In the starting position 116, the shielding element 114 bears against the stop 130. The stop 130 prevents movement of the shielding element 114 beyond the starting position 116 away from the main body 102. The stop 130 may also support the pretensioning force of the spring element 128.

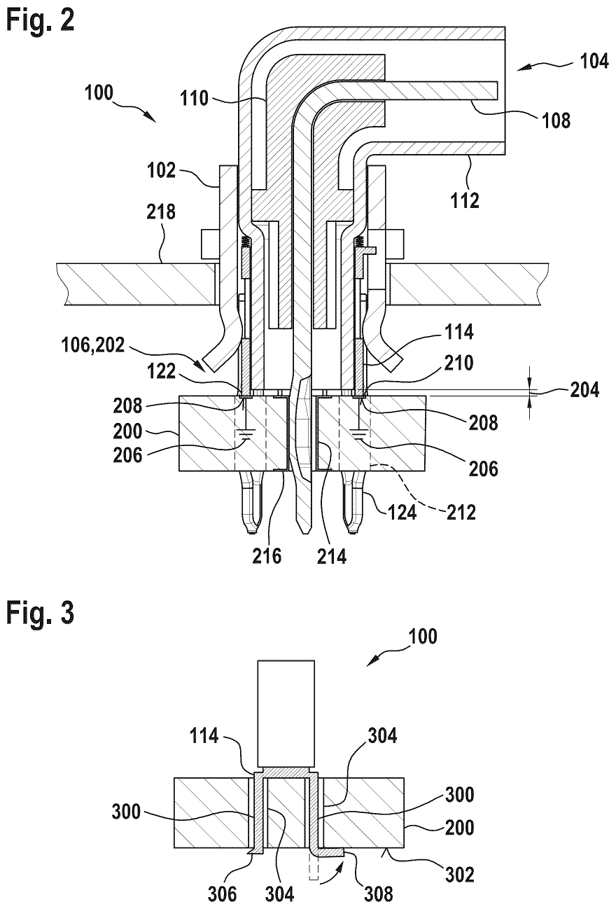

FIG. 2 shows a sectional illustration of a circuit board 200 having a circuit board plug-in connector 100 according to one exemplary embodiment. The circuit board plug-in connector 100 corresponds substantially to the circuit board plug-in connector in FIG. 1.

The circuit board interface 106 of the circuit board plug-in connector 100 is connected to a plug-in connector interface 202 of the circuit board 200. As a result, the shielding element 114 bears against the circuit board 200 and bridges a gap 204 between the main body 102 and the circuit board 200. There is thus no gap between the shielding element 112 and the circuit board 200. The shielding element 114 is electrically conductively connected to a ground potential 206 of the circuit board 200. The shielding element 114 is arranged displaced out of its starting position in the direction of the main body 102. As a result, the shielding element 114 overlaps the shield 112 in a larger overlapping region than in FIG. 1. The shielding element 114 projects only so far out of the main body 102 that the gap 204 is completely bridged. As a result, the electromagnetic shielding of the electrical conductor 108 is ensured continuously.

In one exemplary embodiment, the crenellated structure 122 is pressed into a contact area 208 which is at the ground potential 206 by the pressing force of the shielding element 114 and thus ensures the electrically conductive connection between the shielding element 114 and the ground potential 206.

In one exemplary embodiment, the shielding element 114 is soldered to the contact area 208. For this purpose, a deposit of solder paste has been arranged on the contact area 208 before the circuit board interface 106 is connected to the plug-in connector interface 202. After the connection, the solder paste has been melted by heating to form solder 210. The solder 210 has been cohesively connected to the contact area 208 and the shielding element 114 and ensures a permanent electrically conductive connection.

In one exemplary embodiment, the circuit board interface 106 is pressed into the plug-in connector interface 202. For this purpose, the press-fit pins 124 are pressed into bores 212 of the circuit board 200 and the electrical conductor 108 is pressed into a contact bore 214 of the circuit board 200. The contact bore 214 is connected to electronic components of the circuit board via at least one conductor track 216 of the circuit board 200.

In one exemplary embodiment which is not illustrated, the circuit board interface 106 is soldered to the plug-in connector interface 202. For example, solder pins of the circuit board interface 106 are arranged in the bores 212 and connected to conductor tracks 216 of the circuit board 200, for example by means of flow soldering. Alternatively, contact areas of the circuit board interface 106 have been placed on contact areas of the circuit board 200 with deposits of solder paste. The solder paste has, for example, been melted by heating in an oven to form solder and connects the contact areas.

In one exemplary embodiment, the circuit board plug-in connector 100 is arranged in a plug housing 218 of the circuit board 200. The plug housing 218 has stop surfaces for the circuit board plug-in connector 100 which define an actual relative position and thus also the gap 204 between the circuit board 200 and the circuit board plug-in connector 100. A plurality of circuit board plug-in connectors may be arranged in the plug housing 218. The gap 204 is thus dependent on component tolerances of the plug housing 218, the circuit board 200 and the circuit board plug-in connector 100. Assembly tolerances during pressing in and/or positioning also influence the relative position and the gap 204. As long as the relative position lies within the distance tolerance range, the press-fit pins 124 are reliably pressed into the bores 212 and the shielding element 114 reliably bridges the gap 204.

In one exemplary embodiment, the circuit board plug-in connector 100 is a 90°circuit board plug-in connector 100. That is to say, while in the embodiment illustrated in FIG. 1 the plug face is aligned in such a way that a corresponding plug-in connector may be plugged on in a vertical direction perpendicular to the circuit board, in the embodiment illustrated in FIG. 2 the plug face is aligned in such a way that a corresponding plug-in connector may be plugged on in a horizontal direction parallel to the circuit board. Here, the electrical conductor 108 and the shield 112 are bent at right angles after the overlapping region with the shielding element 114, with the result that they run substantially parallel to the circuit board 200 in the plug face 104. The shield 112 and the shielding element 114 enclose the electrical conductor 108 along its extension and together ensure the electromagnetic shielding from the gap 204 on the circuit board 200 through the circuit board plug-in connector 100 to the plug face 104.

FIG. 3 shows a highly schematized sectional illustration of a secured circuit board plug-in connector 100 according to one exemplary embodiment. The circuit board plug-in connector 100 is connected to a circuit board 200 as in FIG. 2. Here, the shielding element 114 additionally has two anchoring elements 300 which anchor the shielding element 214 on a rear side 302 of the circuit board 200.

For this purpose, when the circuit board plug-in connector 100 is placed, the anchoring elements 300 have been inserted into apertures 304, provided specifically for this purpose, of the circuit board 200 and provide mechanical anchoring on the rear side 302.

In one exemplary embodiment, the anchoring elements 300 have latching hooks 306 which have been elastically deformed upon insertion into the apertures 304. On the rear side, the latching hooks 306 have sprung back into their starting position and thus produce a form fit on the rear side 302.

In one exemplary embodiment, the anchoring elements 300 have plastically deformable tabs 308. The tabs have been threaded through the apertures 304 and have been bent over on the rear side 302. In the bent-over state, the tabs 308 no longer fit through the apertures 304 and thus secure the shielding element 114 in its position on the circuit board 200.

Possible implementations of the invention are summarized again below or illustrated with a slightly different word selection.

An optionally axially movable telescopic shielding element, in particular for vertical (180°) or horizontal (90°) PCB HF plug-in connectors with press-fit technology or soldering technology, is presented.

The approach presented here may be used in the case of printed circuit board plug-in connectors, optionally in sum or module construction, for high frequency (HF) applications with differential or coaxial data transmission.

For other applications, the approach presented here may also be used in the case of sum plug-in connectors or HF PCB plug-in connectors with soldering technology. The approach presented here may be used in particular in the case of plug-in connectors whose shielding may not be soldered in a planar manner (SMD technology) to the PCB GND.

As a result of the addition of different component tolerances, and assembly tolerances of the PCB plug-in connector into the housing and the positioning tolerance in the case of printed circuit board fitting, in the case of press-fit technology (press-fit) or soldering technology, a gap may arise between the printed circuit board and the PCB plug-in connector. For example, the gap may be between 0.1 millimeters and 0.9 mm in size.

With a gap between PCB and PCB plug-in connector that is too large, the shielding specifications may not be complied with. This may lead, for example, to sidetalk, crosstalk, shielding damping and/or coupling damping.

As a result of the approach presented here, the gap between the outer conductor of the PCB plug-in connector and the PCB ground is minimized, at best completely closed.

In order to minimize the gap between the printed circuit board and the PCB plug-in connector, an additional shielding element which is movable in the axial direction has been supplemented.

Before being fitted on the circuit board, this additional shielding element is, for example, in the lowermost position (delivery state).

During the pressing-in process of the press-in contacts of the PCB plug-in connector into the printed circuit board, the additional shielding element collides with the printed circuit board. When the press-in contacts are pushed further to position, the additional shielding element is displaced upward (in the direction of the plug interface), but remains in contact with the printed circuit board and thus closes the gap between the printed circuit board and the PCB plug-in connector. When the pressing-in process of the press-in contacts has ended, the gap remains closed or has been minimized.

Alternatively, the additional shielding element may be pushed upward by the contact with the printed circuit board during the positioning of the PCB plug-in connector on the printed circuit board. During and after the soldering of the PCB plug-in connector to the printed circuit board, the movable shielding element bears against the printed circuit board and closes or minimizes the gap. Optionally, the movable shielding element may also be soldered and thus additionally secured to position.

Finally, it is pointed out that terms such as “having”, “comprising”, etc. do not exclude other elements or steps and terms such as “a”or “an”do not exclude a plurality.

Furthermore, it is pointed out that features or steps which have been described with reference to one of the above exemplary embodiments may also be used in combination with other features or steps of other exemplary embodiments described above. Reference signs in the claims are not to be regarded as a restriction.

### LIST OF REFERENCE SIGNS

100 circuit board plug-in connector
102 main body
104 plug face
106 circuit board interface
108 electrical conductor
110 insulator
112 shield
114 shielding element
116 starting position
118 latching element
120 depression
122 crenellated structure
124 fastening pin or press-fit pin
126 distance tolerance range
128 spring element
130 stop
200 circuit board
202 connector interface
204 gap
206 ground potential
208 contact area
210 solder
212 bore
214 contact bore
216 conductor track
218 plug housing
300 anchoring element
302 rear side
304 aperture
306 latching hook
308 tab

1. A circuit board plug-in connector for high-frequency signals,
wherein the circuit board plug-in connector has a plug face for reversible connection to a corresponding plug-in connector for high-frequency signals, and a circuit board interface for permanent connection to a circuit board,
wherein the plug face and the circuit board interface have at least one continuous electrically conductive electrical conductor,
wherein the plug face has a fixed shield for electromagnetic shielding of the electrical conductor, and
wherein the circuit board interface has a shielding element, mounted movably relative to the electrical conductor, for electromagnetic shielding of the electrical conductor.

2. The circuit board plug-in connector according to claim 1,
wherein the circuit board interface has a distance tolerance range for making contact with the circuit board, wherein the movable shielding element is mounted movably at least within the distance tolerance range.

3. The circuit board plug-in connector according to claim 2,
wherein the circuit board interface has fastening pins for pressing-in into the circuit board, wherein the fastening pins are pressable within the distance tolerance range.

4. The circuit board plug-in connector according to claim 1,
wherein, in an uninstalled state, the shielding element projects out of a main body of the circuit board plug-in connector beyond a stop of the circuit board interface at least by a maximum distance tolerance of the circuit board interface.

5. The circuit board plug-in connector according to claim 1,
wherein the shielding element is supported on a main body of the circuit board plug-in connector via an elastic spring element.

6. The circuit board plug-in connector according to claim 1,
wherein at least one partial region of the shielding element has an interference fit in a main body of the circuit board plug-in connector, wherein at least one of the partial region and the main body is configured to be elastically deformed upon a relative movement of the shielding element.

7. The circuit board plug-in connector according to claim 6,
wherein at least one of the partial region and the main body is configured to enable the relative movement when a minimum force on the shielding element is exceeded.

8. The circuit board plug-in connector according to claim 1,
wherein the shielding element has a crenellated structure at a contact point with respect to the circuit board.

9. The circuit board plug-in connector according to claim 1,
wherein the shielding element has at least one anchoring element, wherein the anchoring element is configured to be arranged in an aperture of the circuit board and to anchor the shielding element on a rear side of the circuit board.

10. The circuit board having at least one circuit board plug-in connector according to claim 1, wherein the circuit board interface is permanently connected to the circuit board, wherein the movably mounted shielding element bears against the circuit board, is electrically conductively connected to a ground potential of the circuit board and bridges a gap between the circuit board and the circuit board plug-in connector.

11. The circuit board according to claim 10, wherein the shielding element penetrates into a contact area of the circuit board which contact area is at the ground potential.

12. The circuit board according to claim 10,
wherein the shielding element is soldered to a contact area of the circuit board which contact area is at the ground potential.

13. The circuit board according to claim 10,
wherein a circuit board plug-in connector is connected to the circuit board, wherein at least one anchoring element of the shielding element is arranged in an aperture of the circuit board and anchors the shielding element on a rear side of the circuit board.
